(19) United States
(12) Patent Application Publication
(10) Pub. No.: US 2005/0060278 A1
(43) Pub. Date: Mar. 17, 2005

(54) Method and arrangement of grammar files in a presentation list

(75) Inventors: Ciprian Agapi, Lake Worth, FL (US); Felipe Gomez, Weston, FL (US); James R. Lewis, Delray Beach, FL (US); Vanessa V. Michelini, Boca Raton, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/664,280

(22) Filed: Sep. 17, 2003

(51) Int. Cl. G06F 7/00

(52) U.S. Cl. 707/1

(57) ABSTRACT

A method (10) of arranging grammar files in a presentation list such as a drop-down list can include the steps of receiving (12) a system request to display the grammar files in the presentation list, and sorting (14) the grammar files by giving user defined grammar files greater priority over built-in grammar files and then sorting by a second criteria. The method can further include the step of displaying (16) the grammar files when a user selects the grammar files and distinguishing between a user defined grammar and a built-in grammar.

### BACKGROUND OF THE INVENTION

1. Technical Field

This invention relates to the field of user interfaces and more particularly to the presentation of lists from which users will make a selection, such as drop-down lists and list boxes.

2. Description of the Related Art

Grammar files can be user generated or voice browser built-in grammars. A default arrangement of grammar files in a list is typically done alphabetically by their name. An alphabetical organization is optimal for some purposes, but not all. One situation in which an alphabetical arrangement is suboptimal is the presentation of grammar files in a callflow development graphical user interface (GUI), given that users can create their own grammar files. In such scenario, an alphabetical arrangement can be cumbersome and less than ideal.

Although there are numerous systems or methods using alphabetical or chronological arrangements, none are ideally suited where a user can create their own grammar files. Thus, a need exists for a system and method that can overcome the detriments described above.

### SUMMARY OF THE INVENTION

Embodiments in accordance with the invention can enable callflow designers to work more efficiently with lists of grammar files in a graphical callflow builder, particularly where users can create their own grammar files. In such a situation, it is better to place the user created grammar files at the top of the list because they are the files that are most likely to be selected by a callflow designer.

In a first aspect of the invention, a method for arranging grammar files in a presentation list can include the steps of receiving a system request to display the grammar files in the presentation list, and sorting the grammar files by giving user defined grammar files greater priority over built-in grammar files and then sorting by a second criteria. The method can further include the step of displaying the grammar files when a user selects the grammar files and distinguishing between a user defined grammar and a built-in grammar.

In a second aspect of the invention, a system for arranging grammar files in a presentation list can include a memory and a processor programmed to receive a system request to display the grammar files in the presentation list and to sort the grammar files by giving user defined grammar files greater priority over built-in grammar files and then sorting by a second criteria.

In a third aspect of the invention, a computer program has a plurality of code sections executable by a machine for causing the machine to perform certain steps as described in the method and systems above.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a flow diagram illustrating a method or arranging user generated and built-in criteria accordance with the present invention.

FIG. 2 is an exemplary instantiation of a callflow GUI with system and user-generated labels for callflow elements and illustrating an associated variable presentation list in accordance with the present invention.

### DETAILED DESCRIPTION OF THE INVENTION

Embodiments in accordance with the invention can provide a solution for optimally arranging grammar files in a presentation list where each file name in the list is sorted first based on whether the file is created by the user or is system or built-in, then on a secondary attribute such as position in an alphabetical list. Using this list strategy for grammar files, a callflow designer will be able to select grammar files faster, and with better accuracy.

For example, imagine a graphical callflow development system, in which a user generates the following grammar files:
airports.jsgf
airlines.jsgf
hotels.jsgf

Furthermore, a browser-defined subset of the grammars could be:
boolean.jsgf
currency.jsgf
digit.jsgf
number.jsgf
time.jsgf

Exposing the combination of these two subsets of grammar files in a GUI, the combined list of grammar files listed in alphabetical order, would look like:
airlines.jsgf
airports.jsgf
boolean.jsgf
currency.jsgf
digit.jsgf
hotels.jsgf
number.jsgf
time.jsgf

In this case, a callflow designer would have a cluttered view of the list of grammar files, where the user-defined grammar files are intermixed with the browser built-in grammar files. Furthermore, an ambiguous situation arises if a user creates a grammar file with the same name as a browser built-in grammar file. For example, a user might create a currency grammar file, which has additional functionality, but is named the same (currency.jsgf).
airlines.jsgf
airports.jsgf
boolean.jsgf
currency.jsgf
currency.jsgf
digit.jsgf
hotels.jsgf
number.jsgf
time.jsgf

If the system would make a distinction between user-defined and built-in grammars, and used that information when sorting the two groups alphabetically and creating the grammar file order, putting user-defined grammar file names at the top of the list, the list would look like:
airlines.jsgf
airports.jsgf
currency.jsgf
hotels.jsgf
boolean.jsgf
currency.jsgf
digit.jsgf
number.jsgf
time.jsgf

Additional visual aid could be presented to a user, in form of a partition of the two subsets of grammar files by a space, dashed line, or group header:
airlines.jsgf
airports.jsgf
currency.jsgf
hotels.jsgf
boolean.jsgf
currency.jsgf
digit.jsgf
number.jsgf
time.jsgf
   or
airlines.jsgf
airports.jsgf
currency.jsgf
hotels.jsgf
boolean.jsgf
currency.jsgf
digit.jsgf
number.jsgf
time.jsgf
   or

User-Defined Grammars:
airlines.jsgf
airports.jsgf
currency.jsgf
hotels.jsgf

Built-in Grammars:
boolean.jsgf
currency.jsgf
digit.jsgf
number.jsgf
time.jsgf

This would make it much easier to work with the grammar files in this type of system, especially as the number of grammar files becomes larger.

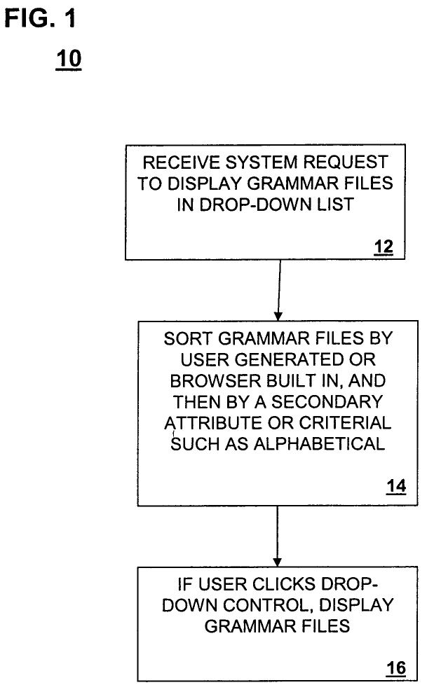

Referring to FIG. 1, a high-level flowchart of a method 10 of optimally arranging grammar files in a presentation list such as a drop-down list in accordance with the present invention is shown. The method 10 can include the step of receiving a system request to display grammar files in a presentation list at step 12. At step 14, the grammar files can be sorted by user generated criteria versus system or browser built-in criteria. The grammar files can then be sorted using other criteria such as a second criteria such as alphabetical order or chronological order. Once a user clicks a drop-down control, the grammar files can be displayed at step 16 in an order that distinguishes between user generated grammar files and built-in criteria. Importantly note that it is possible to have user-defined grammars that have the same name as the built-in grammars, as shown in the last example above (specifically, “Currency” is both a user-defined grammar and a built-in grammar). Although such a system should not allow for two or more user-defined grammars with the same name, the ability and potential for having the same name for a user-defined and built-in grammar illustrates the importance of having some means to distinguish between user-defined and built-in grammars. The distinction can be achieved in any number of ways including, for example, labeling (as shown in the last example) or by having different types of text formatting (such as italics, color, or bolding).

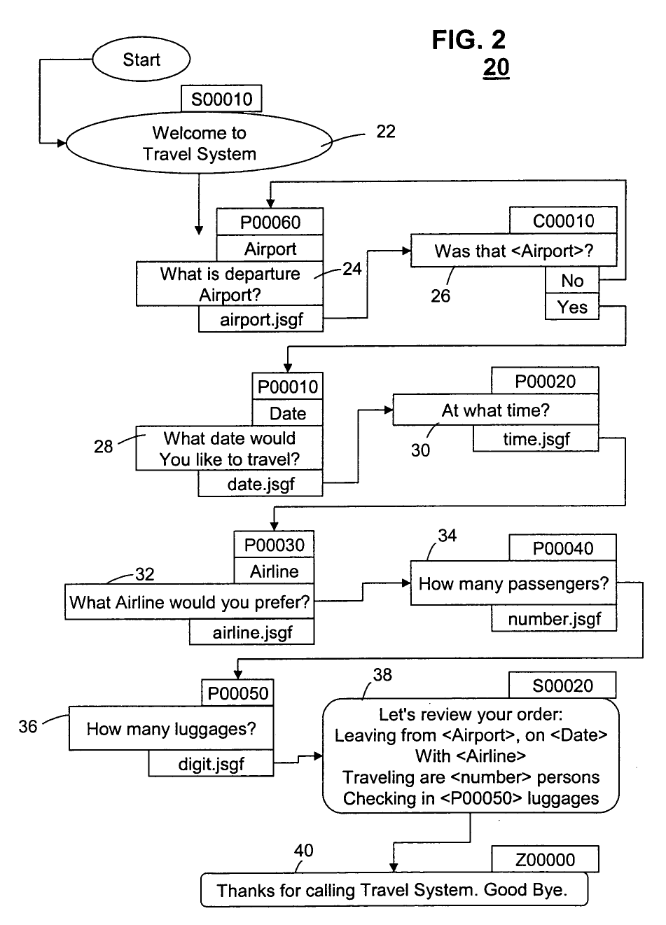

Referring to FIG. 2, an exemplary instantiation of a callflow GUI 20 with system and user-generated labels for callflow elements is shown illustrating an associated variable drop-down list in accordance with the present invention. In particular, the callflow GUI 20 illustrates an airlines reservation system where callflow element 22 welcomes the user to the travel system. Callflow element 24 determines a departure airport using user defined grammar “Airport” or airport.jsgf. Callflow element 26 confirms an entry for Airport. Callflow element 28 determines a departure travel date using user defined grammar “Date” or date.jsgf. Callflow element 30 then determines the time using a built-in grammar of time.jsgf. Next, the callflow element 32 determines the desired airline using the a user-defined grammar “Airline” or airline.jsgf. The callflow GUI 20 can then determine how many passengers will be traveling at callflow element 34 using built-in grammar number.jsgf. Next, the number of pieces of luggage can be determined using callflow element 36 using another built-in grammar such as digit.jsgf. A review and display of the travel order can be achieved using callflow element 38 followed by a goodbye greeting from the travel system using callflow element 40.

It should be understood that the present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of arranging grammar files in a presentation list, comprising the steps of:
receiving a system request to display the grammar files in the presentation list; and
sorting the grammar files by giving user defined grammar files greater priority over built-in grammar files and then sorting by a second criteria.

2. The method of claim 1, wherein the method further comprises the step of displaying the grammar files when a user selects the grammar files.

3. The method of claim 1, wherein the method further comprises the step of distinguishing between a user defined grammar and a built-in grammar.

4. The method of claim 3, wherein the step of distinguishing is accomplished using at least one among labeling and text formatting.

5. The method of claim 3, wherein the user defined grammar files and the built-in grammar files can share the same name.

6. The method of claim 1, wherein the second criteria is an alphabetical order.

7. The method of claim 1, wherein the second criteria is a chronological order.

8. A system for arranging grammar files in a presentation list comprises:
a memory; and
a processor programmed to receive a system request to display the grammar files from the memory in the presentation list and to sort the grammar files by giving user defined grammar files greater priority over built-in grammar files and then sorting by a second criteria.

9. The system of claim 8, wherein the processor is further programmed to display the grammar files when a user selects the grammar files.

10. The system of claim 8, wherein the processor is further programmed to distinguish between a user defined grammar and a built-in grammar.

11. The system of claim 10, wherein the processor is further programmed to distinguish by using at least one among labeling and text formatting.

12. The system of claim 10, wherein the user defined grammar files and the built-in grammar files can share the same name.

13. The system of claim 8, wherein the second criteria is an alphabetical order.

14. The system of claim 8, wherein the second criteria is a chronological order.

15. The system of claim 8, wherein the presentation list is at least one among a drop-down list and a list box.

16. A machine-readable storage, having stored thereon a computer program having a plurality of code sections executable by a machine for causing the machine to optimally arrange grammar files in a presentation list, comprising the steps of:
receiving a system request to display the grammar files in the presentation list; and
sorting the grammar files by giving user defined grammar files greater priority over built-in grammar files and then sorting by a second criteria.

17. The machine-readable storage of claim 16, wherein the machine-readable storage is further programmed to sort by the second criteria being an alphabetical order.

18. The machine-readable storage of claim 16, wherein the machine-readable storage is further programmed to sort by the second criteria being a chronological order.
